(19) United States
(12) Patent Application Publication
(10) Pub. No.: US 2008/0166465 A1
(43) Pub. Date: Jul. 10, 2008

(54) Pectin for Heat Stable Bakery Jams

(75) Inventors: Steen Hojgaard Christensen, Helsingor (DK); Hans Peter Mathiesen, Vaerloese (DK); Karin Meyer Hansen, Herfolge (DK)

Correspondence Address: J M HUBER CORPORATION, 333 THORNALL STREET, PATENT DEPARTMENT, EDISON, NJ, 08837-2220, US

(73) Assignee: CP KELCO U.S., INC., Atlanta, GA (US)

(21) Appl. No.: 11/621,747

(22) Filed: Jan. 10, 2007

(51) Int. Cl. A23L 1/0524; C08B 37/06

(52) U.S. Cl. 426/573; 536/2

(57) ABSTRACT

Disclosed is a pectin having an internal viscosity of about 3 dl/g to about 8 dl/g, preferably about 4 dl/g to about 5 dl/g, a molecular weight of about 185 kDa to about 240 kDa, and a degree of esterification of about 35% to about 40%, more preferably about 37% to about 39%.

### BACKGROUND OF THE INVENTION

Perhaps only slightly less venerable than bread (which itself has been made and eaten by humans since the stone age), jams and jellies owe their ubiquity, at least in part, to their relative ease of manufacture and use: consumers have long been able to make their own products in a home kitchen, and then apply them to bread or pastries.

However, jams are no longer being used solely as a confectionary condiment, and bakery jams, which are closely related to jams, can now also be found in a far wider variety of products from health foods (such as chewy nutrient bars) to indulgent pastries including cakes, Danishes, cookies. These “bakery jams” (also sometimes known as “baking jams” or “bake jams”) have a high “bake stability” for use in industrial cooking processes and also have a viscosity and texture that are particularly suitable for mechanical processing and application into bakery products (e.g., by extrusion) before baking. (This distinguishes bake jams from other jam-like products, such as piping jams, which are added after baking and have different material requirements.)

A variety of consumer and culinary trends are responsible for accelerating the use of bakery jams, but perhaps nutritional and dietetic causes have been the most important. For example, pasties and cookies incorporating whole grain flour have become increasing popular recently and bakery jams are widely used with treats incorporating whole grain flour in order to cover the unusual taste and mouthfeel imparted by the whole grain flour.

As mentioned above, bakery jams are very similar to conventional jams, which themselves are composed of fruit pieces, sugar and a hydrocolloid. Hydrocolloids effectuate gelation in jams, and, as mentioned above, determine other properties that are relevant both for the manufactures (such as “bake stability” and viscosity) and also consumers, such as taste, mouthfeel, texture, and visual appearance. (These properties will be discussed in greater detail, below).

Historically, several different hydrocolloids have been put to use in confectioneries. Gelatin was among the earliest hydrocolloids used, especially in candies and gums. But gelatin is not only ineffective as a hydrocolloid in bakery jams but in recent years it has also become somewhat less preferred by food producers overall because it fails to meet the dietary guidelines of vegetarians and Jewish kosher, and Moslem halal practitioners, and also has a pronounced, if unfair, association with Bovine Spongiform Encephalopathy. Alginates have also been proposed, and while they do perform well in confectionary jams and jellies they can impart an unpleasant flavor note related in its characteristic taste to the origin of alginates as extracts from brown seaweed.

Pectins, which have long been the most widely used hydrocolloid in jams and jellies offer more promise for inclusion in a bakery jam. However, experimental studies and commercial experience have shown that the pectin must be carefully selected. For example, HM pectins (i.e., those pectins having a degree of esterficiation of greater than 50%) would seem to be a highly promising jam hydrocolloid as these pectins are successfully used in a wide variety of food products. Unfortunately, HM-pectin has been shown to impart poor bake stability in jams and jellies (meaning that under high temperature the gel network melts and the material becomes unstable and at least partially liquefies and experience severe syneresis). This poor high-temperature bake stability is believed to be the result of the low gel strength caused by the lack of cross links in HM-pectin as well as the physical limitation that only low concentrations of HM-pectin (e.g. less than 0.3%) can be used without causing a calamitous spike in the viscosity of the product.

As an alternative to HM pectins, LM pectins may be used. LM pectins gel by a different mechanism than HM pectins; in particular they require the presence of divalent ions (typically Ca²⁺ ions), and this resulting gel structure is stronger and more bake stable. Typically, conventional LM pectins are used in bakery jams, as amidated LM pectins (“LMA”), in which a portion of the carboxylic acid groups are replaced by amide groups, will melt at temperatures of above 100° C.

However, LMA pectins bring their own difficulties; notably the presence of amides has meant more stringent government regulation of the material. Several European countries have only recently, and under pressure form existing WTO rules, allowed the use of LMAs in food. Even where LMA is permitted by government regulators, its use may be restricted in other ways. In the United States, for example, LMA may not be used in organic foods, which is not only the fastest growing food sector but also by far the most profitable on a per unit basis. Moreover, while LMA is presently allowed as an ingredient in food in most countries, further questions regarding the safety of LMA could prompt governments to seek additional toxicology studies further limiting the use of LMA and requiring immediate substitution.

And while the above problems have been described in detail with respect to bake jams, they are also pertinent to other types of confectionary jams. In particular they are pertinent to jam sugar, which is a special gelling sugar used instead of conventional white sugar in making jams, jellies, and other preserves.

Given the foregoing there is a need in the art for a pectin material that imparts important performance characteristics such as bake stability, low syneresis, and acceptable processing viscosity when incorporated into a bakery jam or a gelling sufar.

### BRIEF SUMMARY OF THE INVENTION

The present invention relates to a pectin having an internal viscosity of about 3 dl/g to about 8 dl/g, preferably about 4 dl/g to about 5 dl/g, a molecular weight of about 185 kDa to about 240 kDa, and a degree of esterification of about 35% to about 40%, more preferably about 37% to about 39%.

The present invention also relates to a bakery jam comprising a pectin having an internal viscosity of about 4 dl/g to about 5 dl/g, a molecular weight of about 185 kDa to about 240 kDa, and a degree of esterification of about 35% to about 40%, more preferably about 37% to about 39%.

### DETAILED DESCRIPTION OF THE INVENTION

All parts, percentages and ratios used herein are expressed by weight unless otherwise specified. All documents cited herein are incorporated by reference.

The present invention is directed towards a process for making a bakery jam which imparts not only high bake stability but a unique flavor release and smooth thixotropic texture. In the present invention a high filling temperature is not required as the product has a high pumpability that makes it easy to process and due to a thixotropic texture it creates a smooth and coherent jam, with no syneresis.

Bakery Jams

A jam is a confectionary product that includes soluble solids in the form of sugar and solid fruit, as well as pectin, water and other ingredients (discussed in greater detail below). In the United States a “jam” is required by the U.S. Department of Agriculture to have at least 45 wt % of fruit component to each 55 wt % of sweetner solids, with the final soluble solids content of not less than 65%. (Requirements for Specific Standardized Fruit Butters, Jellies, Preserves, and Related Products, 21 C.F.R. §150.140).

All of the aforementioned ingredients perform important functions in a jam. The sugar and fruit, for example, provide the sweetness, taste and organoleptic texture and body that makes jam a desirable spread for bread and pastries. As discussed above, the pectin provides gel formation, and in the case of LM pectins this gel formation occurs by interaction with divalent ions (specifically, Ca²⁺) ions which are supplied by the fruit component or added as a salt. In fact these Ca²⁺ ions must be present at a sufficiently high concentration in order for gellation to occur.

Bakery jams are related to jams, although they differ in the amount of soluble solids they contain. For example, bakery jams with the lowest soluble solids content, of about 30% to about 50%, have a very short life span, and are typically used in, for example, specially baked bread or muffins, or are meant for frozen distribution, such as frozen pie-fillings. The next highest soluble solids content are the bakery jams with soluble solids content of from about 50% to about 65%. These products have a longer shelf life and are used in the production of packaged donuts, muffins and other pastries. Finally there are those products with a soluble solids content of from about 65% to about 80% which are products with very long shelf lives like cookies, toaster pastries, and snack cakes. While the present application is pertinent to products in all of the above soluble solids ranges, it is particularly suitable for bakery jams with a solids content in the range of about 40% to about 80%, more preferably a solid solids content in the range of about 45% to about 75%.

The pH of these bakeryjams will be in the range of about 3.0 to about 4.0, preferably about 3.2 to about 3.8, more preferably about 3.4 to about 3.6.

In the present invention a bakery jam is made by cooking together one or more kinds of fruits along with sugar solids and buffers as well as any other desired ingredients. A pectin solution is then added to this mixture. Techniques for making jams and bakery jams are well known to those of ordinary skill in the art. After manufacture, the bakery jam can be extruded or otherwise applied to a pastry or bakery product or dough and exposed to temperatures of 200° C. and greater.

Each of these jam ingredients will now be discussed in greater detail.

Fruit

In the present invention the fruit component is provided by either intact or chopped whole fruit. The amount of sugar found in the fruit juice concentrates is measured with a refractometer, and is given the unit “°Brix”, or percent sugar. Suitable fruits such as apples, grapes, and berries are further processed by techniques that are well known to those of ordinary skill in the art.

Sugar Solids

The present invention preferably also includes sugar solids in the form of refined cane or beet sugar (sucrose) or glucose syrups (e.g., corn syrup) and their derivates as a source of sugar sweetener solids. These glucose syrups are obtained by the acidic or enzymatic hydrolysis of corn starch, which may be further modified.

Other Ingredients

In addition to the above ingredients, the present compositions may also include other ingredients such as processing aids, buffer salts, and acids. A preferred buffer salt is sodium citrate. Acids may be added when the formulator wants to reduce the pH to a desired range to, inter alia, increase total acidity or to enhance certain fruit flavor notes. Generally the suitable pH range correlates with the final soluble solids level. The acid used in the present invention may be selected from a wide variety of acids such as citric, malic, tartaric, lactic, fumaric, and phosphoric acids. Of the aforementioned acids, citric acid is the most preferred, because it provides excellent pH reduction while imparting smooth taste characteristics.

For some special bakery applications it will be a further advantage to use a combination of pectin and starch. The pectin used in this combination will be the same type as described above, the starch will be a converted type, also referred to as fluidity or thin boiling starches, which are treated with acid or enzyme for reduction of molecular weight. Besides converted starches derivatised starches can be used, these derivatives can include esters such as acetate and half-esters such as the succinate and octenylsuccinate prepared by reaction with sodium or potassium orthophosphate or tripolyphosphate; ethers such as hydroxypropyl ether prepared by reaction with propylene oxide. When starch is used, the jam will comprise about 1 wt % to about 8 wt % and the pectin from about 0.2 wt % to about 1 wt %.

Pectin

Pectins are natural materials that occur in most higher plant forms, forming the major structural components in the primary cell wall and middle lamella of young and growing plant tissues. The structure of pectin itself can be defined as 1,4-linked alpha-D-galactopyranosyluronic acid units in the ⁴C₁ conformation, with the glycosidic linkages arranged diaxially. While the 1,4-linked alpha-D-galactopyranosyluronic acid units form the backbone of the pectin molecule, most pectin is heteropolysacchardic, meaning that other sugars are also present in the backbone or as “branched” neutral sugar side-chains. L-Rhamnose, which is covalently attached to the galacturonan at parts of the backbone, is one of the most common such neutral sugar. The presence of these neutral sugars is important because they contribute significantly to the molecular weight of the pectin; from about 10% to 15% of the molecular weight comes from these neutral sugar side chains. Another important characteristic of the pectin structure that has a much pronounced effect on the pectin's behavior and performance is what fraction of the carboxyl groups attached to the galactopyranosyluronic acid units are esterified with methanol. In commercial usage, pectins having a degree of esterification of less than 50% (i.e., less than 50% of the carboxyl groups are methylated to form methyl ester groups) are classified as low-ester pectins (or “LM-pectins”) while those pectins having a degree of esterficiation of greater than 50%, (i.e., more than 50% of the carboxyl groups are methylated) are classified as high-ester pectins (or “HM-pectins”). The present invention will relate primarily to LM-pectins.

In the present invention, a bakery jam having a combination of excellent bake stability, low syneresis during baking, and a texture that makes the bakery jam easily pumpable during food processing is obtained by using a unique pectin with a high molecular weight and a relatively low DE. The low DE of pectin has important consequences for the pectin as a gelling agent in the bakery jam. LM pectins gel primarily by the presence of Ca²⁺ which forms electrostatic bridges between adjacent galacturonan chains. Because of the bent form of the galacturonan chains, these Ca²⁺ create cavities around themselves which become occupied by carboxyl and hydroxyl groups as well; this activity evokes the image of an eggbox, with the Ca²⁺ ions as eggs ensconced within surrounding galacturonan chains. The lower the DE, the higher the calcium sensitivity and thus the stronger the gel that can be produced by the pectin in the baking jam, unless the gel network becomes to tight, in which case the jam will become very hard and actually shrink because of the continuous strengthening of the ionic bonds, eventually leading to syneresis. Thus, for these applications it is important to have a pectin with a lower DE.

The pectin manufacturer can, to some extent, control the DE as well as the molecular weight and other properties of the pectin by adhering to appropriate processing steps and conditions well known to skilled persons. Typically, pectin is commercially produced by suspending pectin-rich plant tissue, such as citrus pulp or peel, in warm acidified water for some time. (An additional important aspect of the present invention is that the pectin is preferably derived either from lemon peel or orange peel, or a mixture of both.) This part of the pectin manufacturing is commonly referred to as the “extraction”; it converts the insoluble form of pectin as it exists in plants (often referred to as “protopectin”) to soluble pectin which then leaches into the solution. Later, the pectin is recovered from said solution by separation-filtration processes. Then the recovered pectin may be subjected to a chemical deesterification process in which the pectin is suspended in aqueous alcohol solution to which an acid or base is added (adding ammonia results in LMA pectin).

Unfortunately this acid deesterification process is a relatively crude tool that not only reduces the DE of the pectin but also deesterifies the pectin molecule as part of a dramatic physical and chemical restructuring of the pectin molecule. In particular, one unwanted side effect of the acid deesterification is the breaking of the glycosidic linkages (by acid hydrolysis) of the homogalacturonan, the rhamnogalacturonan and between the L-rhamnose linked side-chains, resulting in a significant lowering of the molecular weight of the pectin molecule and a reduction of the side chain sugar molecules leading to a more homopolysacchardic molecule. Reduction of the DE can also be done by using a pectin esterase, which has the effect of removing the ester groups without any effect on other molecular characteristics.

By the present invention it has been discovered that when a pectin characterized as having a low DE, a high molcular weight, and a high intrinsic viscosity is incorporated into a bakery jam, the result is a bakery jam with excellent heat stability, low syneresis, and a thixotropic behavior that allows it to be pumped during manufacturing and subjected to extrusion, while holding its shape and stability at all other times. Accordingly, in the present invention the DE of the pectin is reduced not by chemical or physical methods, but by treating the pectin with an enzyme that deesterifies pectin. Such enzymes, generically referred to as pectin esterases, are well known. The enzymes hydrolyse some of the methyl-esterified carboxyl groups producing non-esterified carboxyl groups and methanol. As a result of treatment with pectin esterase enzymes, the pectin has a lower DE, but does not have its neutral sugar side chains eliminated or its molecular weight reduced; so a pectin is produced with a unique set of characteristics that make it particularly suitable as a gelling agent in bakery jams and low sugar jams in general. (One disadvantage of using a pectin esterase is that it is difficult to reduce the % DE of the pectin to below 30%, so in order to reduce the % DE to less than 30%, an enzyme treatment can be combined with an alkali treatment.) These unique set of characteristics include a % DE of about 10% to about 50%, more preferably about 15% to about 47%; a molecular weight is in the range of about 110 to about 240 KDa, more preferably from about 130 kDa to about 190 kDa, and an intrinsic viscosity, η, of about 3 dl/g to about 8 dl/g, preferably about 4 dl/g to about 5 dl/g. The sugar side chains are preserved to such an extent that the pectin is not a homopolysacchardic but has a galacturonic acid content of between about 85% and about 95%.

As mentioned above, an additional important aspect of the present invention is that the pectin is preferably derived either from lemon peel, orange peel or a mixture of both. Most preferably, for the reasons that follow, the pectin is derived from a mixture of lemon peel and orange peel. A lemon pectin with a molecular weight and % DE in the ranges set forth above will provide the jam with very high bake stability at relatively low concentrations; however, the texture at lower concentrations will be hard and show some syneresis. However, blending a lemon pectin with an orange pectin (having a molecular weight and % DE within the ranges set forth above) will reduce the gel strength and so decrease syneresis as well as creating a more smooth texture as compared to using the lemon peel alone. Depending on the preferred texture the orange pectin can be use in mix with the lemon pectin ranging from 1:1 to 3:1, in order to keep the same bake stability, the concentration should be increased according to the amount of orange pectin added. Thus, by using a mixture of pectin derived from lemon peel and pectin derived from orange peel one can impart to a product improved texture, syneresis, bake stability and pumbability all at a competitive price. When the pectin is extracted from an orange raw material, the molecular weight will preferably be between 185 kDa to about 240 kDa; when the pectin is extracted from a lemon raw material, the molecular weight will preferably be between 170 kDa to about 200 kDa.

Descriptions of hydrocolloid structure and functionality often present theoretical explanations of performances and structures for which there is an inherent element of randomness, and so while not wishing to be limited by theory, a number of factors may be proposed to explain how the superior performance characteristics of the presently inventive pectin preparation for bakery jams are obtained. The calcium reactivity of the pectins play an important part creating a heat stable product as the ionic linkages support a stable pectin network at temperatures as high as 200° C. Calcium reactivity is mainly related to the DE, the pectin becomes more calcium reactive the lower the DE. Also molecular weight has an influence on calcium reactivity, as the pectin becomes more calcium reactive when molecular weight goes up. Still if the pectin becomes too calcium reactive for the product, syneresis will occur or the gel strength will be too high and the gel become very hard. As such it will be necessary to optimize the product to have the texture expected by the customer without syneresis, and without loosing bake stability. In addition, the presence of “branched” neutral sugar side chains, in which orange pectin is especially rich, provide a more open structure, leading to a more soft and thixotropic texture allowing high gum content, which has a positive effect on syneresis. The high gel strength makes the gelled bakery jam even more bake stable and thus more resistant to melting, instability, gel-degradation; and the addition of more highly branched pectin derived from orange peel reduces syneresis during baking-a bakery jam containing pectin according to the present invention has excellent temperature stability in all temperatures under 200° C., especially in the range of 175° C. to 200° C. Additionally, a pectin having higher molecular weight and higher intrinsic velocity, and lower DE, and high content of neutral sugars will have a number of beneficial effects when included in a bakery jam including: (1) lower water mobility and activity so that syneresis is reduced even though the presence of the strong gels created by pectin of the present invention would have conventionally tended to push water out of the gel; and (2) reduced water mobility and activity means that there is less chance of the formation of ice crystals in the bakery jam as the temperature is reduced, which would make extrusion almost impossible; accordingly this means that the bakery jam incorporating the pectin of the present invention is extrudable over a wider range of temperatures; (3) a thixotropic texture allowing the pectin to be easily extruded during manufacture of baked goods.

In addition to improved viscosity, bake stability and syneresis performance, the present pectins also impart improved temperature (“freeze-thaw”) stability in a bakery jam. Temperature Stability refers to the ability of the bakery jam to maintain its phase stability (i.e., avoid phase separation or syneresis) during one or more cycles of temperature changes between ambient and very cold temperatures (while the freezing point of water may be approximately 0° C., manufacturers of frozen confectioneries like ice cream often store their products at far lower temperatures, such as −40° C.). Ice crystals are the primary cause of temperature instability because they can fracture, disrupt or otherwise physically damage a gel structure. Additionally, large or numerous ice crystals can lead to rampant coalescence resulting in syneresis or phase instability.

LMC and HM-pectin types are naturally preferable in freeze-thaw applications because, unlike LMA-pectins, they are thermoirreversible, but additionally the reduced water mobility and activity mentioned above with respect to viscosity also contributes to temperature stability by binding the water into the gel structure so the water is not available as free water and the product has an overall low level of water mobility or activity. This prevents the formation of ice crystals or at the very least reduces their size.

The process of the present invention can be practiced according to methods well known to those of ordinary skill in the art and making use of standard laboratory equipment. The pectin production steps including the extraction and recovery steps as well as pectin esterase hydrolysis step are well-known to those of ordinary skill in the art. However, on an industrial scale the process is most conveniently practiced using specialized manufacturing equipment. Suitable mixers for making the bakery jam include the powder impeller mixer (also known as a “Tri-blender”) as described in U.S. Pat. No. 3,606,270. Application of the bakery jam by extrusion is particularly envisioned. Suitable techniques are disclosed in U.S. Pat. Nos. 3,908,032 and 6,528,102 as well as in the publication, “Sugar Confectionary Manufacture”, E. B. Jackson, Ed., Glasgow: 1993.

The invention will now be described in more detail with respect to the following, specific, non-limiting examples.

### EXAMPLE 1

Pectin was prepared according to the present invention either from dried lemon and orange peel. Extraction time was 3 hours at a high temperature 70° C. and a pH of around 2. The pectin extract is recovered by being filtered, ion exchanged and evaporated. The recovered pectin is then deesterified by treatment with pectin esterase at pH 4.8 and 35° C. for a period sufficient to reach DE between 35 and 40%, the enzyme is then inactivated by heating to 70° C. at pH 2.5 for 10 min. This extract is then precipitated 1:3 in 80% 2-propanol, and washed with 60% 2-propanol, dried in a heat cabinet 24 hours, milled, and sieved.

Five different pectin samples were then tested for heat stability and syneresis by preparation of a bakery jam with pH 3.5 and 60% soluble solids. Of these five pectin samples, the first sample pectin was derived from orange peel and the second sample pectin derived from lemon peel; the third and fourth samples were blends of the pectin derived from orange peel and pectin derived from lemon peel, and the fifth sample was a prior art pectin. The jam was based on raspberries, sucrose, glucose syrup and sodium citrate, which are cooked together, and the pectin is dissolved in water and added to the jam. Different amounts of calcium citrate were also added. The jam was then allowed to stand for 72 hours. An iron ring having a diameter of 35 mm was then placed on a sheet of filter paper and the sample is then applied to the surface of the filter paper within the ring. A circle was drawn on the filter paper around the ring, which was then removed. The sample was then baked at two different temperatures, 175° C. and 200° C., for 10 minutes and then allowed to cool. The baking index was determined by measuring the sample diameter, and the diameter is determined by placing a liner across the sample, and depending on the shape of the sample 2 to 4 lines were drawn, and the average was calculated. The baking index (BI) was calculated as 100−((Diameter of sample in mm after baking−Diameter of sample before baking 35 mm)/35)·100).

(As can be seen in the formula, the highest achievable index is 100 when the sample was completely stable and no spreading of the jam is observed. The lowest achievable index was set to 0 whenever the sample diameter is 70 mm or higher.)

Syneresis was evaluated by turning the filter paper and evaluating the amount of water penetrating on a scale from 1 to 3, where 1 was almost no water penetrating, 2 was moderate amount of water penetrating and 3 was excessive water penetration.

TABLE 1

| | Break | Bake index | Bake index | |
|---|---|---|---|---|
| Sample | strength | at 175° C. | at 200° C. | Syneresis |
| Lemon | 942 g | 99 | 91 | 2 |
| Orange | 492 g | 71 | 54 | 1 |
| Blend 1 | 290 g | 91 | 86 | 1 |
| Blend 2 | 639 g | 97 | 91 | 1 |
| Competitor | 211 g | 92 | 80 | 3 |

As can be seen in Table 1, pectin samples tested from lemon raw materials showed a BI of 100 and only moderate syneresis. By contrast, prior art samples showed less bake stability and poor syneresis. Pectin samples from orange raw material showed a bake stability of between 70 and 80, but with no syneresis. The blends incorporating both pectin samples from orange raw material and pectin samples from lemon raw material gave the best bake stability (with BI of approaching and exceeding 90) and no syneresis.

As can be seen It was found that in bakery jams incorporating pectins having a % DE between 35% and 40% in combination with an IV of 7 or higher gave the highest BI and only moderate syneresis.

### EXAMPLE 2

Pectin was prepared according to the present invention from dried lemon and orange peel. Extraction time was 3 hours at a high temperature 70° C. and a pH of around 2. The pectin extract is recovered by being filtered, ion exchanged and evaporated. The recovered pectin is then deesterified by treatment with pectin esterase at pH 4.8 and 35° C. for a period sufficient to reach DE of 30%, the enzyme is then inactivated by heating to 70° C. at pH 2.5 for 10 min. This extract is then further deesterified to 20% DE, by treatment NaOH, as described below.

Deesterification with NaOH.

1 kg of pectin with 30% DE is suspended in 5 L 60% 2-propanol at 5° C. and a sufficient amount of NaOH is added. The preparation is stirred for 1 hour. After 1 hour the pectin is drained and washed with 20 L. of 60% 2-propanol at 5° C., while stirring for 15 min. The preparation is then filtered and washed again with 20 L 60% 2-propanol while stirring and pH is adjusted to 5 with 10% HNO₃ for 30 min. and drained for 5 min. A final pH adjustment to pH 5.0-5.2 is done using HNO₃, stirring for 30 min. The preparation is then dried in a heat cabinet 16 hours, milled, and sieved.

Pectin samples prepared as above were then tested for heat stability and syneresis by preparation of a bakery jam with pH 3.5 and 75% soluble solids. The jam was based on strawberries, sucrose, glucose syrup and sodium citrate, which are cooked together, and the pectin is dissolved in water and added to the jam. Different amounts of calcium citrate were also added. The jam was then allowed to stand for 72 hours. Baking Index and syneresis, were determined as described above. The resulting jams showed great shape stability and no syneresis.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A pectin having an internal viscosity of about 3 dl/g to about 8 dl/g, preferably about 4 dl/g to about 5 dl/g, a molecular weight of about 185 kDa to about 240 kDa, and a degree of esterification of about 35% to about 40%, more preferably about 37% to about 39%.

2. The pectin to claim 1, wherein the pectin has a galacturonic acid content of between about 80% and about 95%.

3. The pectin according to claim 1, wherein the pectin is extracted from a citrus source selected from the group comprising lemon, orange and lime.

4. A bakery jam comprising the pectin according to claim 1.

5. The bakery jam according to claim 4, wherein the bakery jam has a soluble solids content of about 40% to about 80%, preferably about 45% to about 75%

6. The bakery jam according to claim 4, wherein the bakery jam has a pH of about 3.2 to about 3.8, more preferably about 3.4 to about 3.6.

7. The bakery jam according to claim 1, wherein the bakery jam has excellent temperature stability in the range of 175° C. to 200° C.

8. The pectin according to claim 1, wherein the pectin is extracted from a citrus source selected from the group comprising lemon and orange.

9. The pectin according to claim 1, wherein the pectin is extracted from a lemon citrus source.

10. The pectin according to claim 1, wherein the pectin is extracted from an orange citrus source.

11. A bakery jam comprising a pectin having an internal viscosity of about 4 dl/g to about 5 dl/g, a molecular weight of about 185 kDa to about 240 kDa, and a degree of esterification of about 35% to about 40%, more preferably about 37% to about 39%.

12. The bakery jam according to claim 11, wherein the bakery jam has a soluble solids content of about 40% to about 80%, preferably about 45% to about 75%.

13. The pectin according to claim 11, wherein the pectin is extracted from a citrus source selected from the group comprising lemon and orange.

14. The bakery jam according to claim 11, wherein the bakery jam has excellent temperature stability in the range of 175° C. to 200° C.

15. The bakery jam according to claim 11, wherein the pectin has a molecular weight of about 170 kDa to about 200 kDa.
